(19) United States
(12) Patent Application Publication
(10) Pub. No.: US 2006/0012456 A1
(43) Pub. Date: Jan. 19, 2006

(54) Anti-interference transformer

(76) Inventors: Cheng-Chia Hsu, Chupei City (TW); Teng-Kang Chang, Jhudong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/159,355

(22) Filed: Jun. 23, 2005

(30) Foreign Application Priority Data
Jul. 16, 2004 (TW) 093211253

(51) Int. Cl. H01F 27/28

(52) U.S. Cl. 336/180

(57) ABSTRACT

An anti-interference transformer composed of a windings base, two cores and windings, the windings base having a plurality of isolating walls disposed externally thereto and through which a primary side and a secondary side are formed, and the windings base having a hollow structure for reception of the two cores combined, the two combined cores being designed so that an additional magnetic path is provided between the primary and secondary sides to provide a magnetic leakage which is prevented from leaking to the outside and by which an amount of the magnetic leakage is controlled.

### BACKGROUND OF THE INVENTION

1. Field of Invention

The present invention relates to an anti-interference transformer and particularly to an anti-interference transformer used in a backlight driver of liquid crystal display (LCD), in which cores thereof are particularly designed to achieve the purpose of anti-interference by providing an additional magnetic path so as to enhance quality stability of such anti-interference transformer.

2. Description of the Prior Art

FIG. 1A, FIG. 1B and FIG. 1C are top views of transformers used in a backlight driver of liquid crystal display (LCD). As shown in FIG. 1A, the conventional transformer 1 is composed of a winding base 11, E-shaped cores 12 and 13 and windings 14. External to the winding base 11, isolating walls 111 are disposed, between which windings 14 of different characteristics are disposed in such a manner that a primary side 15 and a secondary side 16 are formed. Within a hollow structure of the winding base 11, the E-shaped cores 12,13 are received and fixed in a specific combination. As such, the transformer 1 is formed. In this kind of transformer 1, a magnetic leakage φ 11 is caused in the primary side 15, a magnetic leakage φ 22 in the secondary side 16 and a magnetic leakage φ 12 between the primary and secondary sides 15,16. Since such magnetic leakage 11,22,12 may distribute in the air, other devices external to the transformer 1 is susceptible to interference brought thereby or the transformer is susceptible to influence of other magnetic devices, leading characteristics of the transformer 1 to be instable and even become exceptional. Now referring to FIG. 1B, the transformer 1a is formed with the combination of a C-shaped core 12a and an I-shaped core 13a and also presents the magnetic leakage as mentioned with respect to FIG. 1A. Referring further to FIG. 1C, the transformer 1b is formed with the combination of two U-shaped cores 12b13b and also presents the magnetic leakage as mentioned with respect to FIG. 1A.

In view of these problems encountered in the prior art, the Inventors have paid many efforts in the related research and finally developed successfully an anti-interference transformer used in a backlight driver of LCD, which is taken as the present invention.

### SUMMARY OF THE INVENTION

It is, therefore, an object of the present invention to provide an anti-interference transformer, in which cores thereof are particularly designed to achieve the purpose of anti-interference by proving an additional magnetic path so as to enhance quality stability of such anti-interference transformer.

It is another object of the present invention to provide an anti-interference transformer that magnetic leakage caused may be prevented from interfering other devices external thereto or being interfered by other magnetic devices and thus the advantages of improved device characteristics and prolonged lifetime may be achieved. The anti-interference transformer according to the present invention is composed of a winding base, cores and windings. External to the windings base, isolating walls are disposed, between which windings of different characteristics are disposed in such a manner that a primary side and a secondary side are formed. Within a hollow structure of the windings base, cores are received and fixed in a specific combination. The cores are particularly designed so that an additional magnetic path is provided between the primary and secondary sides, the additional magnetic path providing a magnetic leakage. As such, the magnetic leakage may not further leak to the outside and the magnetic leakage may be controlled by the magnetic path.

### BRIEF DESCRIPTION OF THE DRAWINGS

The drawings disclose an illustrative embodiment of the present invention which serves to exemplify the various advantages and objects hereof, and are as follows:

FIG. 1A through FIG. 1C are top view of conventional transformers used in a backlight driver of liquid crystal display (LCD), respectively;

FIG. 2A is a top view of an anti-interference transformer according to a first embodiment of the present invention;

FIG. 2B is a schematic view of cores of the anti-interference transformer according to the first embodiment of the present invention;

FIG. 3A is a top view of the anti-interference transformer according to a second embodiment of the present invention;

FIG. 3B is a schematic view of cores of the anti-interference transformer according to the second embodiment of the present invention;

FIG. 4A is a top view of the anti-interference transformer according to a third embodiment of the present invention;

FIG. 4B is a schematic view of cores of the anti-interference transformer according to the third embodiment of the present invention;

FIG. 5A is a top view of the anti-interference transformer according to a fourth embodiment of the present invention;

FIG. 5B is a schematic view of cores of the anti-interference transformer according to the fourth embodiment of the present invention;

FIG. 6A is a top view of the anti-interference transformer according to a fifth embodiment of the present invention;

FIG. 6B is a schematic view of cores of the anti-interference transformer according to the fifth embodiment of the present invention;

FIG. 7A is a top view of the anti-interference transformer according to a sixth embodiment of the present invention; and

FIG. 7B is a schematic view of cores of the anti-interference transformer according to the sixth embodiment of the present invention.

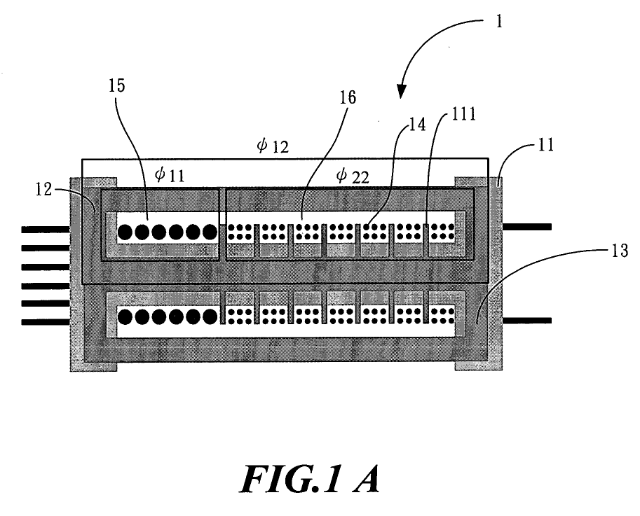

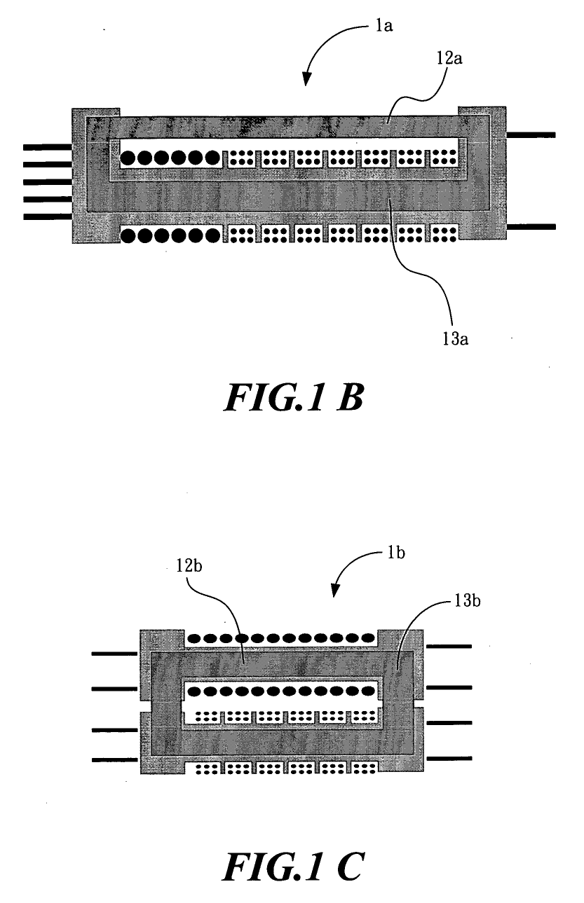

### DETAILED DESCRIPTION OF THE INVENTION

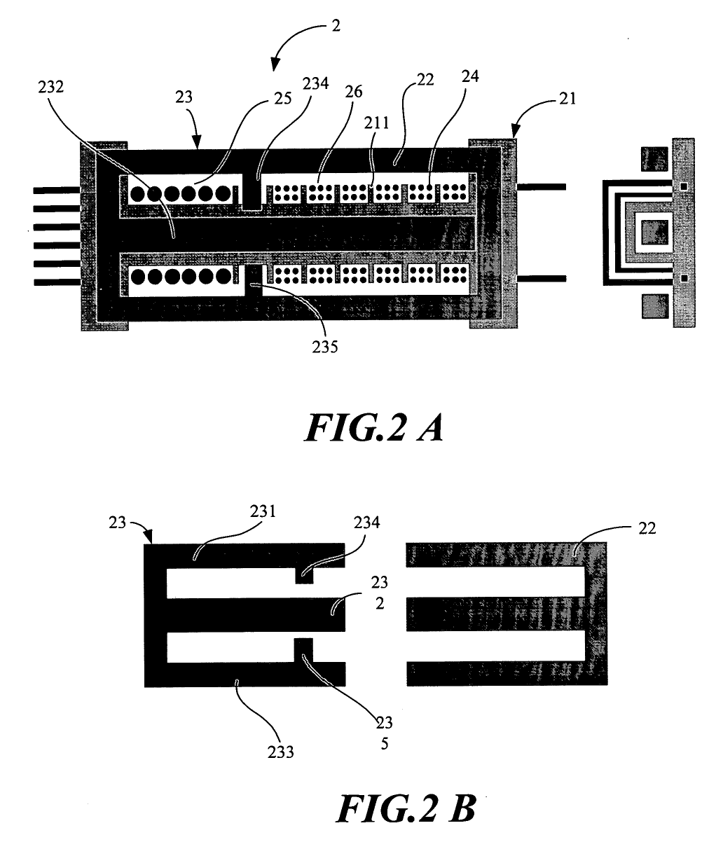

Referring to FIG. 2A and FIG. 2B, a top view of an anti-interference transformer according to a first embodiment of the present invention and a schematic view of a core of the anti-interference transformer are shown therein. As shown, the anti-interference transformer 2 is composed of a windings base 21, two cores 22,23 and windings 24. External to the windings base 21, a plurality of isolating walls 211 are disposed, between which windings 24 of different characteristics are disposed in such a manner that a primary side 25 and a secondary side 26 are formed. Within a hollow structure of the windings base 21, two cores 22,23 are received and fixed in a specific combination. The cores 22,23 are an E-shaped core 22 and an E-shaped core 23, wherein the E-shaped core 23 has a first and a third branches 231,233 extending towards a second branch 232 as a fourth branch 234 and a fifth branch 235 and a gap is provided between the second branch 232 and the fourth branch 234 and the fifth branch 235, respectively. When the cores 22,23 are combined with the windings base 21, the fourth branch 234 and the fifth branch 235 are fixed between the primary and secondary sides 25,26. With the cores 22,23 thus designed, an additional magnetic path is provided between the primary and secondary sides 25,26, the additional magnetic path providing a magnetic leakage. As such, the magnetic leakage may not further leak to the outside and the magnetic leakage may be controlled by the magnetic path. Therefore, the transformer 2 may be prevented from interference and product stability of the transformer is thus enhanced.

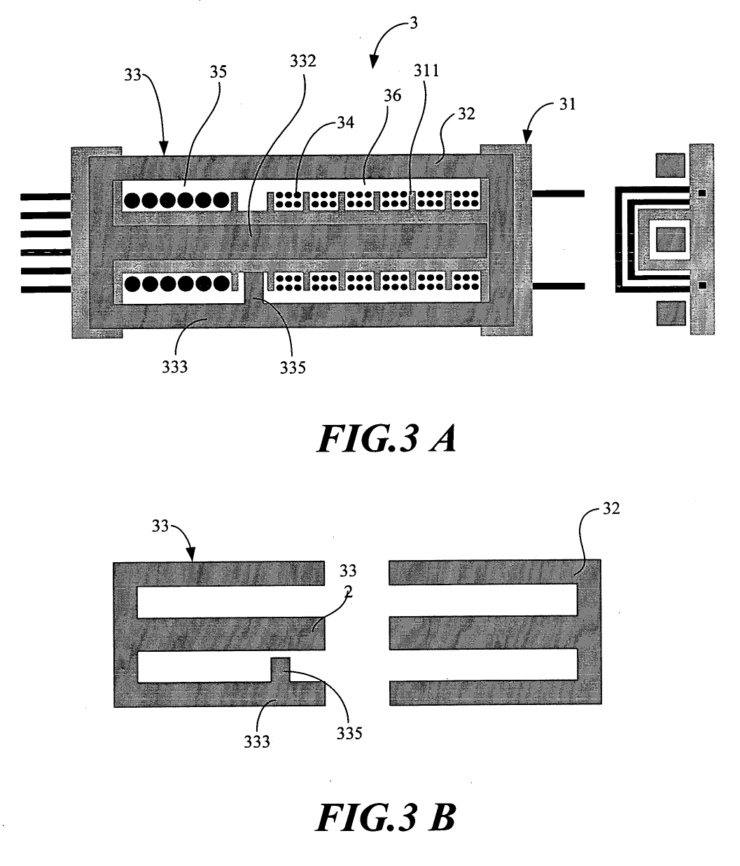

Referring to FIG. 3A and FIG. 3B, a top view of the anti-interference transformer according to a second embodiment of the present invention and a schematic view of a core of the anti-interference transformer are shown therein. As shown, the anti-interference transformer 3 is composed of a windings base 31, two cores 32,33 and windings 34. External to the windings base 31, a plurality of isolating walls 311 are disposed, between which windings 34 of different characteristics are disposed in such a manner that a primary side 35 and a secondary side 36 are formed. Within a hollow structure of the windings base 31, two cores 32,33 are received and fixed in a specific combination. The cores 32,33 are an E-shaped core 32 and an E-shaped core 33, wherein the E-shaped core 33 has a third branches 333 extending towards a second branch 332 as a fifth branch 335 and a gap is provided between the second branch 332 and the fifth branch 335. When the cores 32,33 are combined with the windings base 31, the fifth branch 335 is fixed between the primary and secondary sides 35,36. With the cores 32,33 thus designed, an additional magnetic path is provided between the primary and secondary sides 35,36, the additional magnetic path providing a magnetic leakage. As such, the magnetic leakage may not further leak to the outside and the magnetic leakage may be controlled by the magnetic path. Therefore, the transformer 3 may be prevented from interference and product stability of the transformer is thus enhanced.

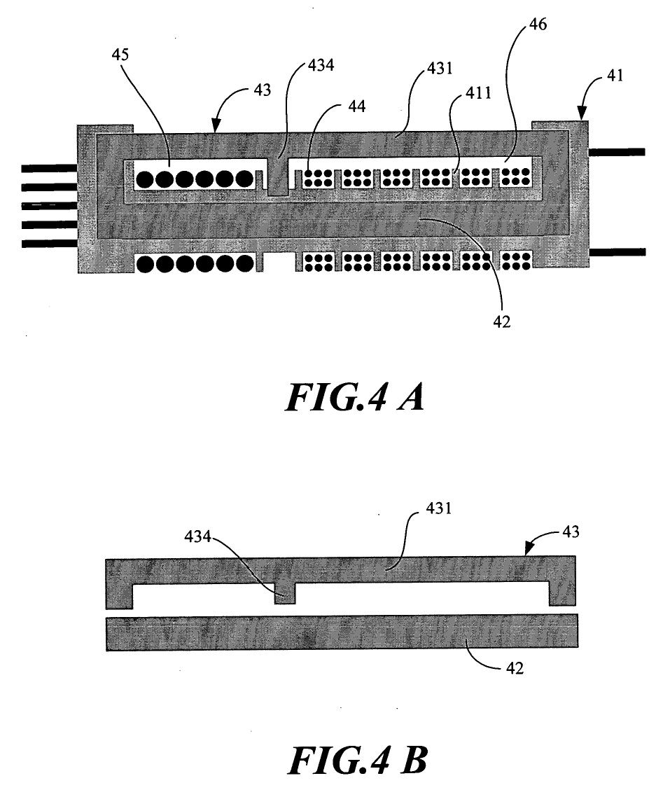

Referring to FIG. 4A and FIG. 4B, a top view of the anti-interference transformer according to a third embodiment of the present invention and a schematic view of a core of the anti-interference transformer are shown therein. As shown, the anti-interference transformer 4 is composed of a windings base 41, two cores 42,43 and windings 44. External to the windings base 41, a plurality of isolating walls 411 are disposed, between which windings 44 of different characteristics are disposed in such a manner that a primary side 45 and a secondary side 46 are formed. Within a hollow structure of the windings base 41, two cores 42,43 are received and fixed in a specific combination. The cores 42,43 are an I-shaped core 42 and a C-shaped core 43, wherein the C-shaped core 43 has a first branch 431 extending to further have a fourth branch 434. When the cores 42,43 are combined with the windings base 41, the fourth branch 434 is fixed between the primary and secondary sides 45,46 and a gap is provided between the fourth branch 434 and the I-shaped core 42. With the cores 42,43 thus designed, an additional magnetic path is provided between the primary and secondary sides 45,46, the additional magnetic path providing a magnetic leakage. As such, the magnetic leakage may not further leak to the outside and the magnetic leakage may be controlled by the magnetic path. Therefore, the transformer 4 may be prevented from interference and product stability of the transformer is thus enhanced.

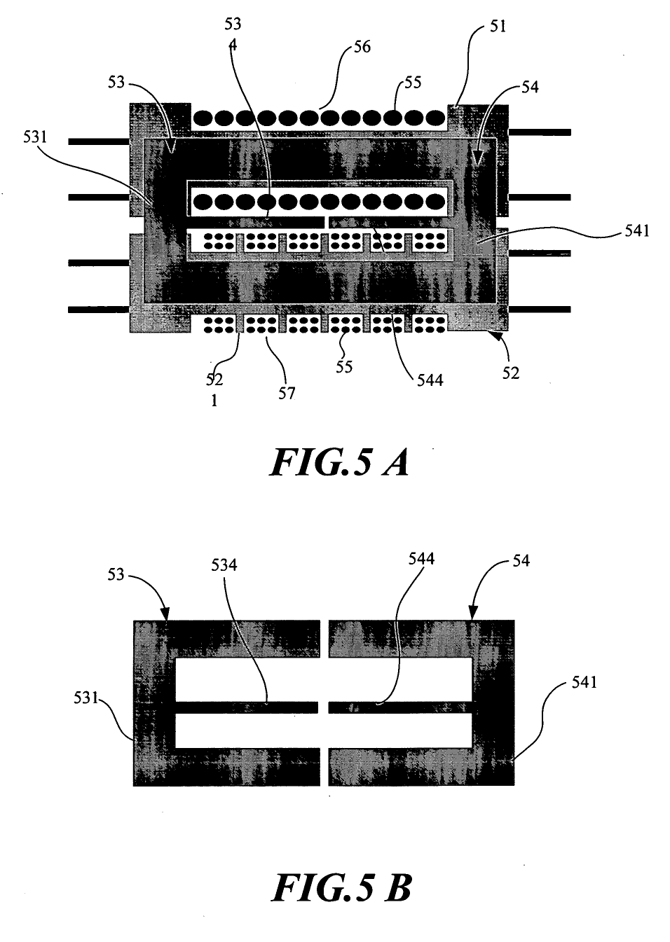

Referring to FIG. 5A and FIG. 5B, a top view of the anti-interference transformer according to a fourth embodiment of the present invention and a schematic view of a core of the anti-interference transformer are shown therein. As shown, the anti-interference transformer 5 is composed of two windings bases 51,52, two cores 53,54 and windings 55. External to the windings base 51, windings 55 are disposed to form a primary side 56. External to the windings base 52, a plurality of isolating walls 521 are disposed between which windings 55 of different characteristics are disposed to form a secondary side 57 in such a manner that the primary side 56 and the secondary side 57 face each other. Within a hollow structure of each of the windings base 51,52, two cores 53,54 are received and fixed in a specific combination. Each of the cores 53,54 has a U-shaped structure with a first branch 531 or 541. Between the first branch 531 or 541, a fourth branch 534 or 544 is extended. When the cores 53,54 are combined with the windings base 51, the fourth branch 534,544 are fixed between the primary and secondary sides 56,57. With the cores 53,54 thus designed, an additional magnetic path is provided between the primary and secondary sides 56,57, the additional magnetic path providing a magnetic leakage. As such, the magnetic leakage may not further leak to the outside and the magnetic leakage may be controlled by the magnetic path. Therefore, the transformer 5 may be prevented from interference and product stability of the transformer is thus enhanced.

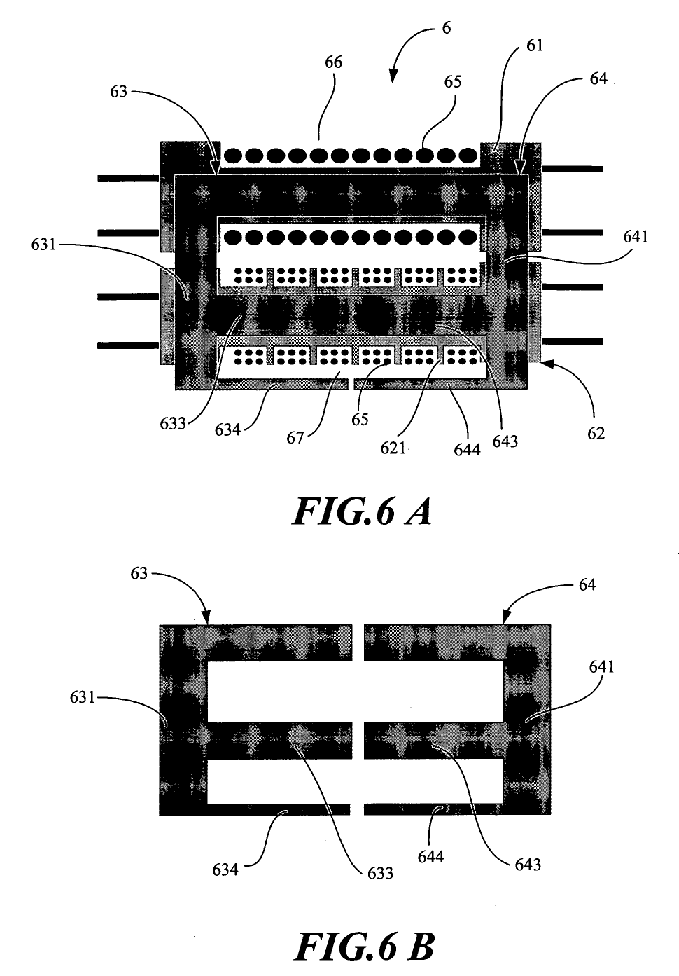

Referring to FIG. 6A and FIG. 6B, a top view of the anti-interference transformer according to a fifth embodiment of the present invention and a schematic view of a core of the anti-interference transformer are shown therein. As shown, the anti-interference transformer 6 is composed of two windings bases 61,62, two cores 63,64 and windings 65. External to the windings base 61, windings 65 are disposed to form a primary side 66. External to the windings base 62, a plurality of isolating walls 621 are disposed between which windings 55 of different characteristics are disposed to form a secondary side 67 in such a manner that the primary side 56 and the secondary side 57 face each other. Within a hollow structure of each of the windings base 61,62, two cores 63,64 are received and fixed in a specific combination. Each of the cores 63,64 has a U-shaped structure with a first branch 631 or 641. An L-shaped fourth branch 634 or 644 is extended towards the secondary side 67 from the first branch 631 or 641 and in parallel with the fourth branches 634,644 and the third branches 643. When the cores 63,64 are combined with the windings bases 61,62, the L-shaped fourth branches 634,644 are fixed externally to the secondary side 67 and a gap is provided between the two L-shaped fourth branches 634,644. With the cores 63,64 thus designed, an additional magnetic path is provided external to the secondary side 67, the additional magnetic path providing a magnetic leakage. As such, the magnetic leakage may not further leak to the outside and the magnetic leakage may be controlled by the magnetic path. Therefore, the transformer 6 may be prevented from interference and product stability of the transformer is thus enhanced.

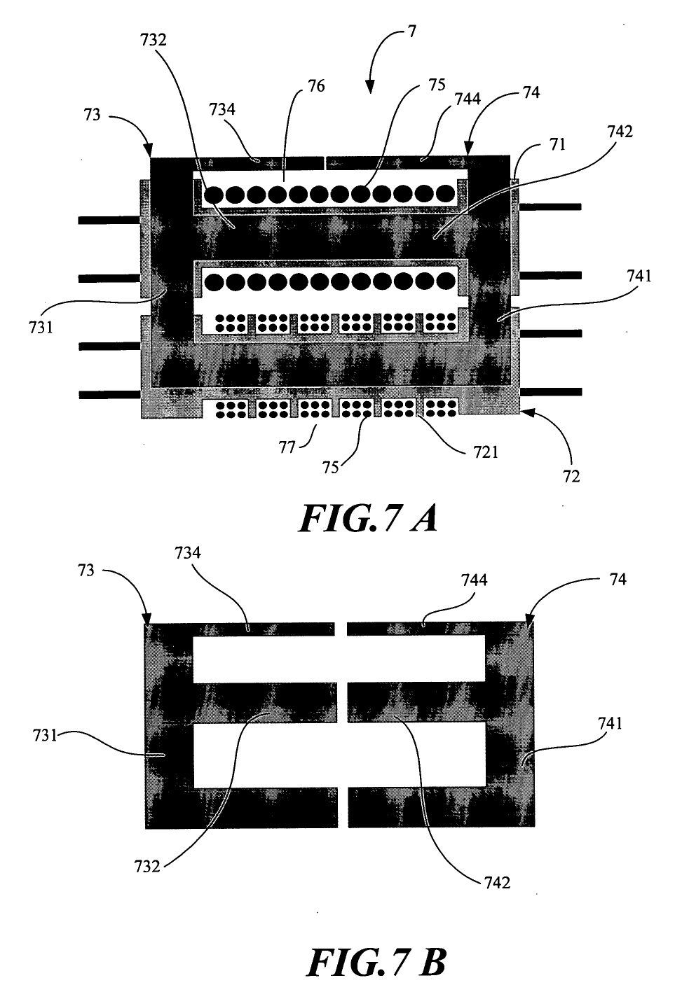

Referring to FIG. 7A and FIG. 7B, a top view of the anti-interference transformer according to a sixth embodiment of the present invention and a schematic view of a core of the anti-interference transformer are shown therein. As shown, the anti-interference transformer 7 is composed of two windings bases 71,72, two cores 73,74 and windings 75. External to the windings base 71, windings 75 are disposed to form a primary side 76. External to the windings base 72, a plurality of isolating walls 721 are disposed between which windings 75 of different characteristics are disposed to form a secondary side 77 in such a manner that the primary side 76 and the secondary side 77 face each other. Within a hollow structure of each of the windings base 71,72, two cores 73,74 are received and fixed in a specific combination. Each of the cores 73,74 has a U-shaped structure with a first branch 731 or 741. An L-shaped fourth branch 734 or 744 is extended towards the primary side 76 from the first branch 731 or 741 and in parallel with the fourth branches 734 or 744 and the second branches 732 or 742. When the cores 73,74 are combined with the windings bases 71,72, the L-shaped fourth branches 734,744 are fixed externally to the primary side 76 and a gap is provided between the two L-shaped fourth branches 734,744. With the cores 73,74 thus designed, an additional magnetic path is provided external to the primary side 76, the additional magnetic path providing a magnetic leakage. As such, the magnetic leakage may not further leak to the outside and the magnetic leakage may be controlled by the magnetic path. Therefore, the transformer 7 may be prevented from interference and product stability of the transformer is thus enhanced.

As compared to the prior art, implementation of the inventive anti-interference transformer may bring at least the following advantages. 1. Since the cores of the anti-interference transformer are particularly designed and thus an additional magnetic path is provided, the purposes of interference prevention and enhanced product stability with respect to the anti-interference transformer are achieved. 2. Since the magnetic leakage may be prevented from interfering other devices external thereto or being interfered by other magnetic devices, the advantages of improved device characteristics, simple manufacture and prolonged lifetime with respect to the anti-interference transformer may be achieved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An anti-interference transformer composed of a windings base, two cores and windings, the windings base having a plurality of isolating walls disposed externally thereto and through which a primary side and a secondary side are formed, and the windings base having a hollow structure for reception of the two cores combined, the two combined cores being designed so that an additional magnetic path is provided between the primary and secondary sides to provide a magnetic leakage which is prevented from leaking to the outside and by which an amount of the magnetic leakage is controlled.

2. The anti-interference transformer according to claim 1, wherein each of the two cores is an E-shaped core and one of the two cores has a first branch and a third branch extending towards to a second branch as a fourth branch and a fifth branch, each having a gap with respect to the second branch and each being fixed between the primary side and the secondary side.

3. The anti-interference transformer according to claim 1, wherein each of the two cores is an E-shaped core and one of the two cores has a third branch extending towards a second branch to form a fifth branch having a gap with respect to a second branch and formed between the primary and secondary sides when the two cores are combined with the windings base.

4. The anti-interference transformer according to claim 1, wherein the two cores are an I-shaped core and a C-shaped core and the C-shaped core has a first branch extending from the fourth branch, which is fixed between the primary and secondary sides and has a gap with respect to the I-shaped core when the two cores are combined with the windings base.

5. An anti-interference transformer composed of first and second windings bases, two cores and windings, the first windings base having the windings disposed external thereto, the second windings base has a plurality of isolating walls disposed externally thereto and between which windings are disposed to form a secondary side so that the primary side and the secondary side face each other, and each of the first and second windings base having a hollow structure for reception of the two cores combined, the two combined cores being designed so that an additional magnetic path is provided between the primary and secondary sides or at one of the primary and secondary sides to provide a magnetic leakage which is prevented from leaking to the outside and by which an amount of the magnetic leakage is controlled.

6. The anti-interference transformer according to claim 5, wherein each of the two cores has a U-shaped structure with a first branch and a fourth branch is extended therefrom, and the fourth branch is fixed between the primary and secondary sides and a gap is provided between the fourth branches of the two cores when the two cores are combined with the windings base.

7. The anti-interference transformer according to claim 5, wherein each of the two cores has a U-shaped structure with a first branch and a fourth branch is extended therefrom towards the secondary side to form an L-shaped branch so that the L-shaped branch is parallel with the third branch, and the L-shaped fourth branch is fixed externally to the secondary side and a gap is provided between the two L-shaped fourth branches of the two cores when the two cores are combined with the windings base.

8. The anti-interference transformer according to claim 5, wherein each of the two cores has a U-shaped structure with a first branch and a fourth branch is extended therefrom towards the primary side to form an L-shaped branch so that the L-shaped branch is parallel with the second branch, and the L-shaped fourth branch is fixed externally to the primary side and a gap is provided between the two L-shaped fourth branches of the two cores when the two cores are combined with the windings base.
